(19) United States
(12) Patent Application Publication
(10) Pub. No.: US 2020/0230634 A1
(43) Pub. Date: Jul. 23, 2020

(54) MODULE FOR A MODULAR CHANGING DEVICE FOR COATING MATERIALS AND CHANGING DEVICE FOR COATING MATERIALS

(71) Applicant: EISENMANN SE, Böblingen (DE)

(72) Inventors: Katrin Piscol, Herrenberg (DE); Tillmann Friederich, Stuttgart (DE)

(21) Appl. No.: 16/487,038

(22) PCT Filed: Jan. 16, 2018
(86) PCT No.: PCT/EP2018/051031

§ 371 Date: Aug. 19, 2019

(30) Foreign Application Priority Data
Feb. 20, 2017 (DE) 10 2017 103 454.4

(51) Int. Cl. B05B 12/14; F16K 27/00

(52) U.S. Cl. CPC B05B 12/149; B05B 15/55; F16K 27/003

(57) ABSTRACT

A module for a modular changing device for coating materials, particularly for paints, having a housing, a fluid channel to which a fluid material is supplied from outside, and an outflow channel that can be connected to a consumer device and is connected to the fluid channel by a flow path. The flow path between the fluid channel and the outflow channel can be selectively closed or opened by a closing device. The fluid channel is a through-channel and extends between a first connection point accessible from the outside, on a first connection point side of the housing, and a second connection point, accessible from the outside, on a second connection point side of the housing, the two connection points of the fluid channel being complementary to each other in such a way that, for two interconnected modules, the second connection point of the first module and the first connection point of the second module are interconnected in a fluid-tight manner, and/or the outflow channel is a first outflow channel and the module comprises a second outflow channel or a plurality of other outflow channels, which are respectively connected to the fluid channel or to a plurality of fluid channels by a flow path.

The invention concerns a module for a modular changing device for coating materials, in particular for paints, with
a) a housing;
b) a fluid channel to which a fluid material can be supplied from the outside;
c) a discharge channel that can be connected to a consumer device and is connected to the fluid channel by means of a flow path;

wherein
d) the flow path between the fluid channel and the discharge channel can be selectively closed or opened by means of a closing device.

The invention also concerns a changing device for coating materials which is constructed from several modules.

A changing device for coating materials, in the case of a painting plant, a paint changing device, is normally used when, in normal operation, it repeatedly occurs that in order to coat an object, a different paint must be used than the paint with which the previous object was coated.

A module for a changing device and a changing device of the type described initially are known from U.S. Pat. No. 6,892,764 B2. The module described there comprises as an discharge channel a single paint channel which is extended into a paint change device when individual modules are joined together. This paint channel is connected in operation to a spray gun via a paint hose. A paint changing device of modular construction has the advantage that it can easily be extended or reduced by a module, whereby the paint changing device can be adapted according to the number of paints to be used in the respective situation.

However, with this known paint changing device, paint can always only be supplied to a single consumer, for example an application device such as a high-rotation atomizer. If several consumers are to be supplied with one or more coating materials, a corresponding paint changing device must be provided for each existing consumer.

It is therefore an object of the invention to provide a module for a changing device, and a changing device for coating materials, of the type described initially which increases the flexibility of the changing device relative thereto.

This object is achieved with a module for a changing device of the type described initially, in that
e) the fluid channel is formed as a through-channel and extends between a first connection accessible from the outside, on a first connection side of the housing, and a second connection accessible from the outside, on a second connection side of the housing,
   wherein
   the two connections of the fluid channel are formed so as to be complementary to each other such when two modules are connected together, the second connection of the first module and the first connection of the second module are connected together fluid-tightly;

and/or
f) the discharge channel is a first discharge channel and the module comprises a second discharge channel or several further discharge channels, which are each connected to the fluid channel by means of a flow path.

In this way, it is possible that with a changing device constructed from two or more modules, two or more discharge channels are available which are supplied from a common fluid channel.

In the first alternative, the number of discharge channels can be increased by joining modules together, so that at least two or more discharge channels may be available in the changing device. In the second alternative, several discharge channels may already be present in a module, and by joining the modules together, the number of fluid channels and hence the supply possibilities for fluid materials can be increased. If the fluid channels in this case are also configured as through-channels, the number of discharge channels can also be increased, namely with each module, by the number of discharge channels in the module.

In order to be able to increase the number of fluid channels in the changing device, it is favorable if
a) the discharge channel is formed as a through-channel and extends between a first connection accessible from the outside, on a first discharge side of the housing, and a second connection accessible from the outside, on a second discharge side of the housing;
b) the two connections of the discharge channel are formed so as to be complementary to each other such that when two modules are connected together, the second connection of the first module and the first connection of the second module are connected together fluid-tightly.

With this configuration, the existing discharge channel or channels can be extended with each additional module. Since each module has at least one fluid channel for the coating material, then with each module the number of fluid channels in the changing device increases.

It is advantageous if the first connection of the fluid channel and/or the discharge channel, and/or the second connection of the fluid channel and/or the discharge channel, are formed as complementary openings which cooperate with a sealing element.

It is favorable if the fluid channel is a first fluid channel and the module comprises a second fluid channel or several further fluid channels which can each be supplied with fluid material from the outside. Thus the number of fluid channels and supply possibilities for fluid materials already available for each module is increased.

It is advantageous if the closing device comprises a valve which is actuated by compressed air and can be loaded with compressed air via a compressed air input connection.

A changing device may advantageously be activated via a type of universal supply module if
a) the compressed air input connection is a first compressed air input connection on the first connection side of the module, and the module comprises at least one second compressed air input connection on the first connection side, which is connected via a connecting channel to a compressed air output connection on the second connection side,

wherein
b) the first compressed air input connection and the compressed air output connection are formed so as to be complementary to each other such that when two modules are connected together, the compressed air output connection of the first module and the first compressed air input connection of the second module are connected together fluid-tightly.

In this embodiment, the compressed air can be conducted through at least one of two interconnected modules to the second module, the valve of which is to be actuated.

This concept may be implemented for a greater number of modules if the module has a number M≥3 of compressed air input connections and a number N=M−1 of compressed air output connections, wherein every further compressed air input connection after the third is connected via a connecting channel to a respective one of the further compressed air output connections after the second, and every compressed air input connection after the second and every compressed air output connection after the second are formed so as to be complementary to each other such that when two modules are connected together, every compressed air input connection after the second said connection of the first module is connected to a respective compressed air output connection after the second said connection of the second module.

The above object is achieved in the changing device of the type described initially if the at least one module is formed as a module with some or all of the features presented above.

With regard to the above-mentioned central supply of the modules, it is favorable if a supply module is provided which can be connected to the module and provides one or more external supply connections for fluid materials, wherein an existing external supply connection can be connected to a first connection of an existing fluid channel.

For this, it is particularly advantageous if the supply module has a coupling connection for each existing first connection of a fluid channel of the module, wherein said coupling connection is connected to an external supply connection and is complementary to the first connection of the fluid channel.

It is also favorable if the supply module comprises one or more external compressed air connections which are connected to compressed air supply connections, which in turn are complementary to existing compressed air input connections of a module.

In practice, it is favorable if, on the side of the at least one or more modules remote from the supply module, a base module is arranged which comprises one or more discontinuous fluid channels formed as blind channels, each of which terminates a fluid channel formed as a through-channel of the adjacent module. If this base module also comprises an discharge channel connected to its fluid channels, coating material can also be delivered on the path via the base module.

Some embodiments of the invention are explained in more detail below with reference to the drawings. These show:

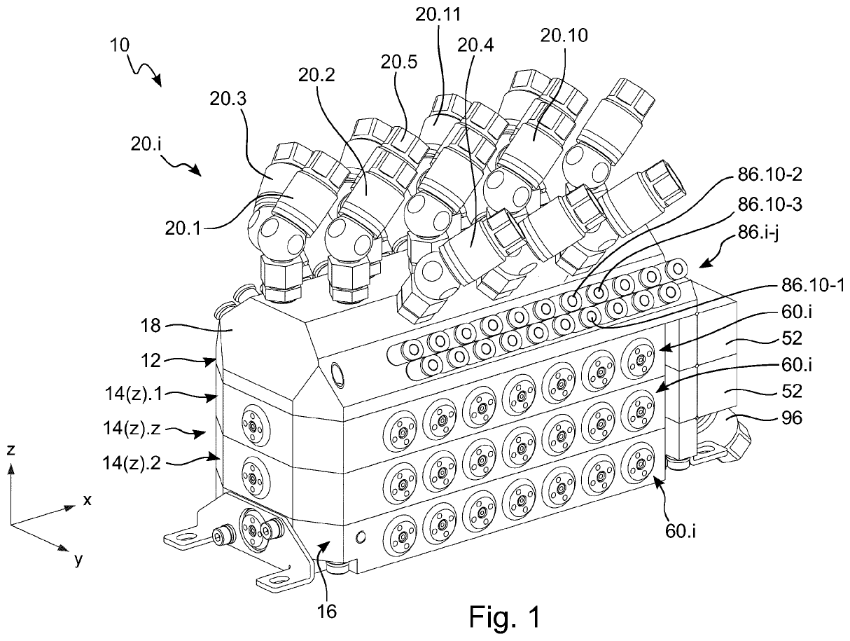

FIG. 1 a perspective view of a modular changing device according to a first embodiment, which comprises a supply module, several distribution modules and a base module, and in which only the number of discharge connections can be configured by the number of distribution modules;

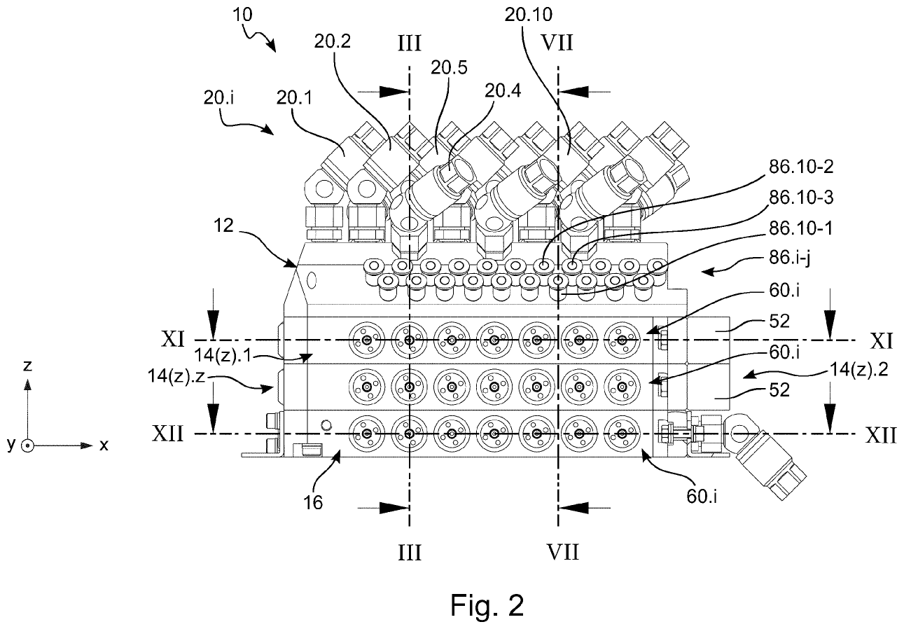

FIG. 2 a side view of the changing device from FIG. 1;

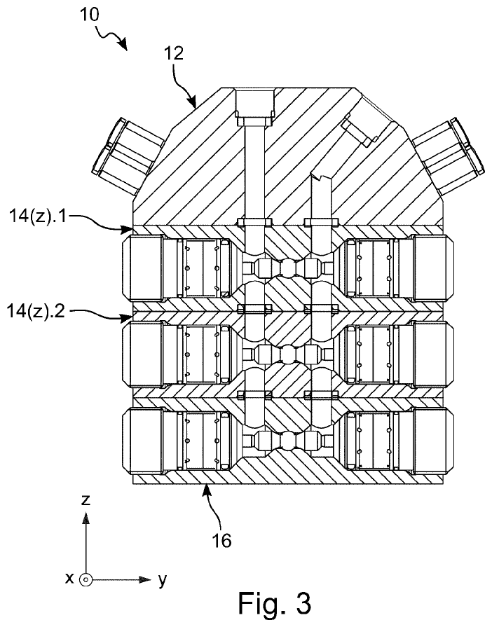

FIG. 3 a vertical section through the changing device from FIG. 2 along the cut line III-III, wherein not all external connections evident in FIG. 2 are shown;

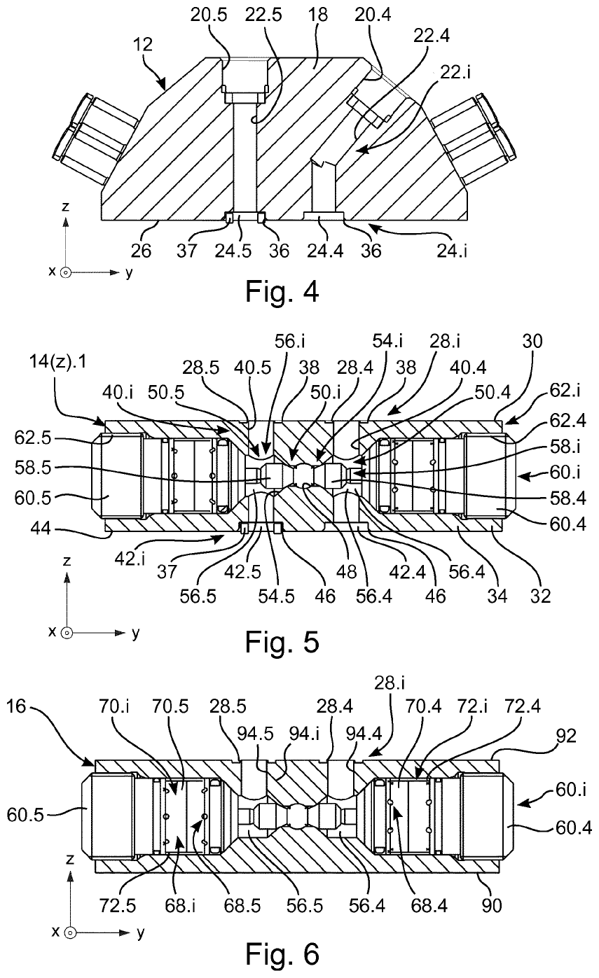

FIG. 4 the supply module in cross-section according to FIG. 3;

FIG. 5 a distribution module in cross-section according to FIG. 3;

FIG. 6 the base module in cross-section according to FIG. 3;

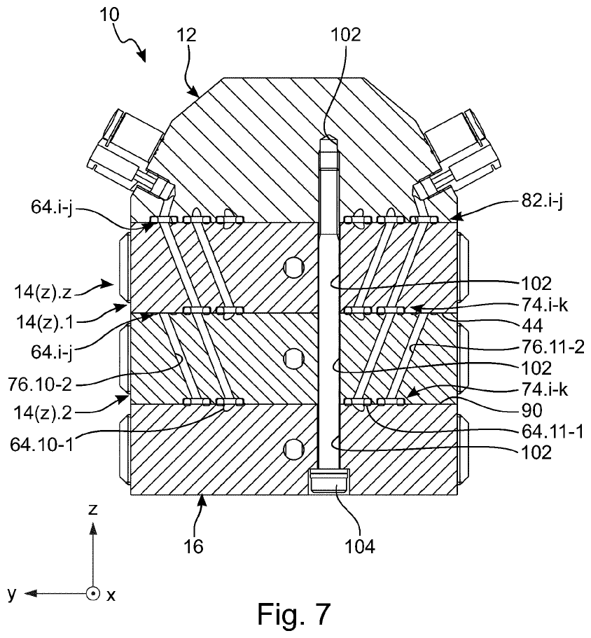

FIG. 7 a vertical section of the changing device of FIG. 2 along line VII-VII, wherein connections evident in FIG. 2 are not shown;

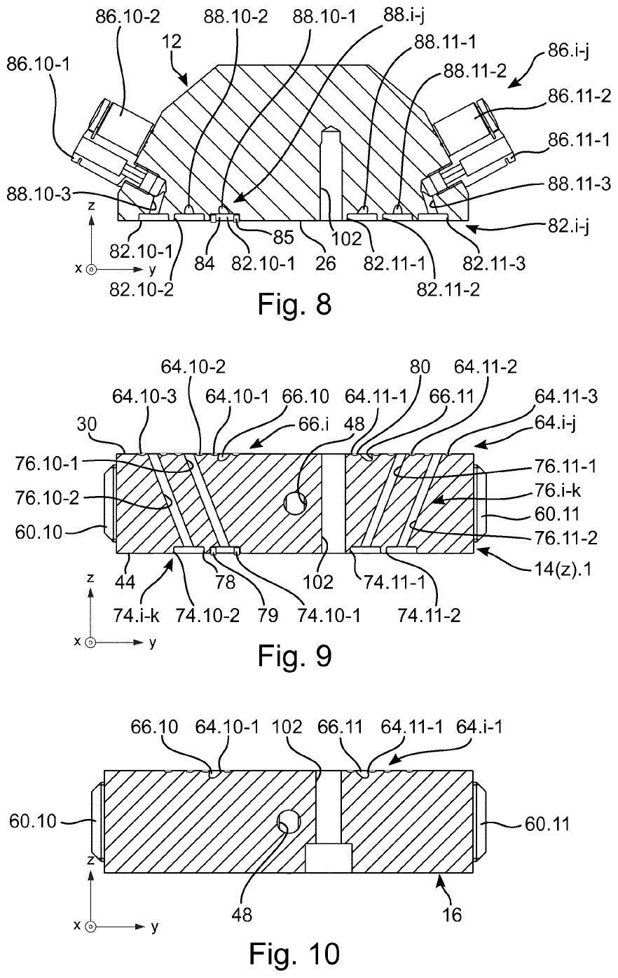

FIG. 8 the supply module in cross-section according to FIG. 7;

FIG. 9 a distribution module in cross-section according to FIG. 7;

FIG. 10 the base module in cross-section according to FIG. 7;

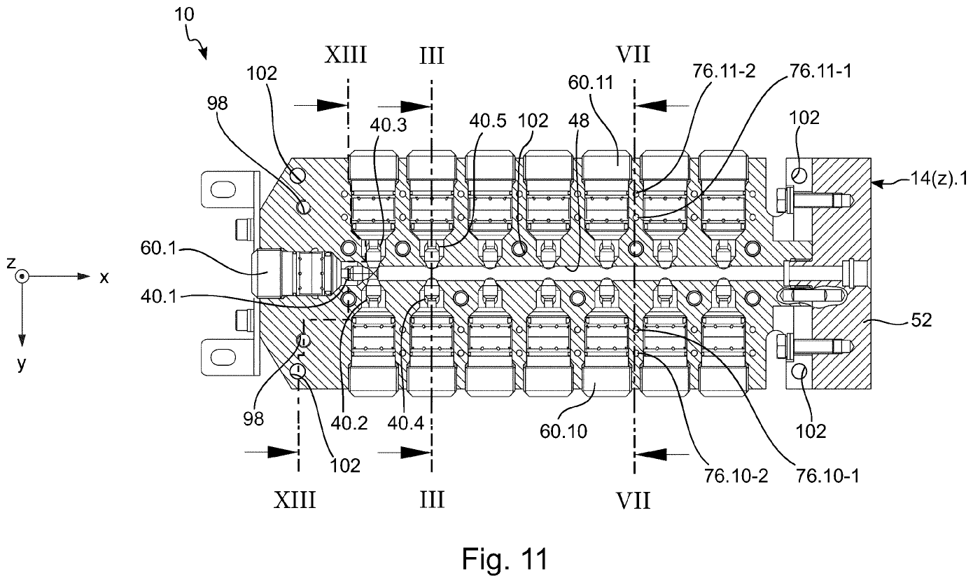

FIG. 11 a horizontal section of a distribution module along cut line XI-XI in FIG. 2;

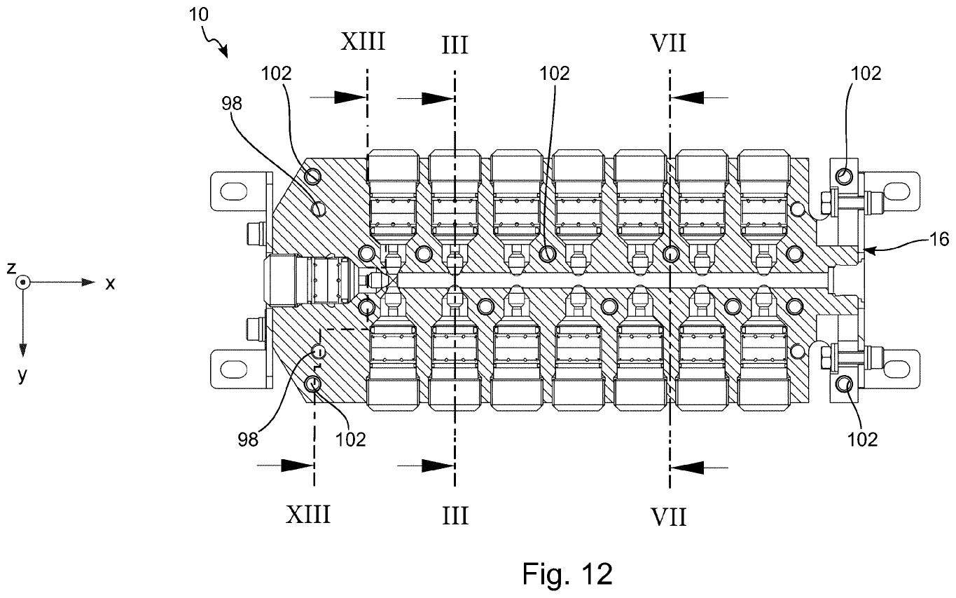

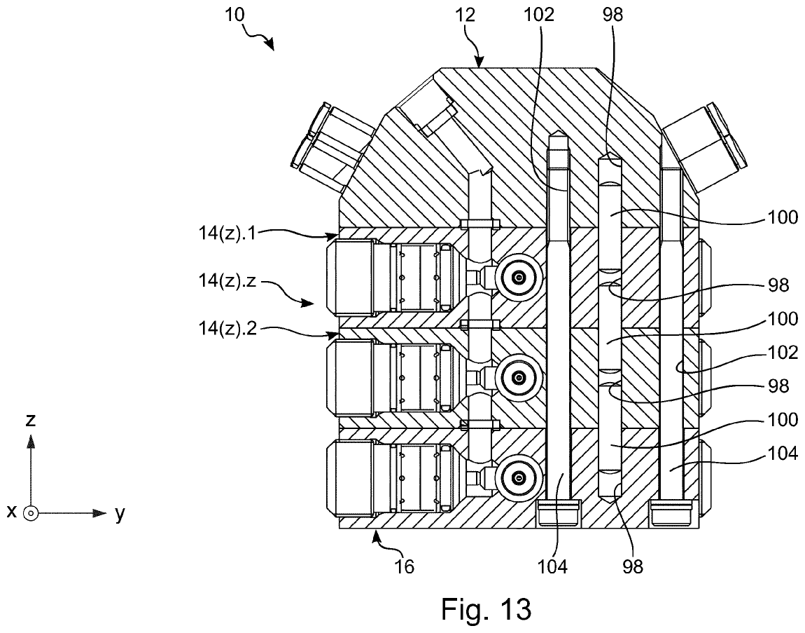

FIG. 12 a horizontal section of the base module along cut line XII-XII in FIG. 2;

FIG. 13 a vertical section of the changing device along the angled cut line XIII-XIII in FIGS. 11 and 12;

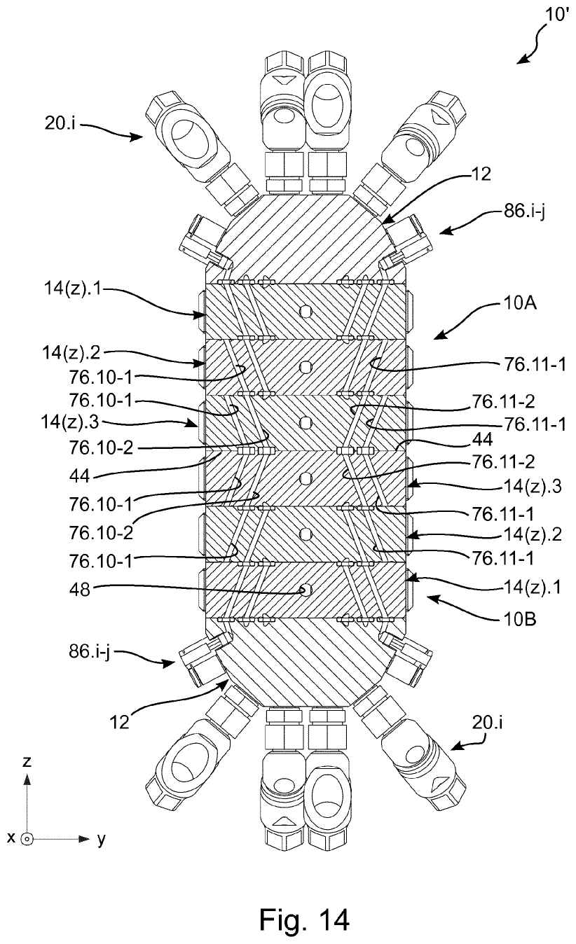

FIG. 14 a changing device according to a second embodiment, which is formed from two changing devices according to FIG. 1, in each of which, instead of the base module, a respective distribution module is provided;

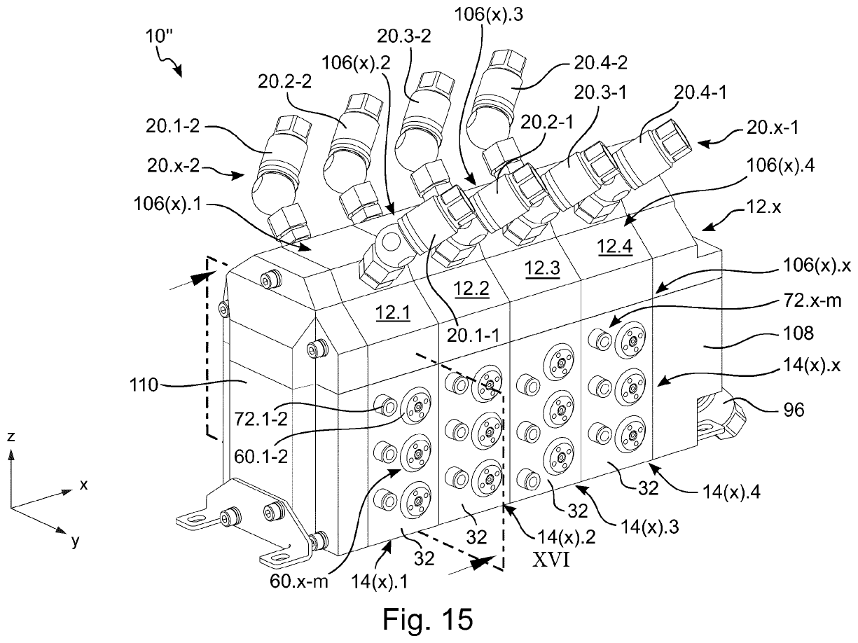

FIG. 15 a perspective view of a modular changing device according to a third embodiment, in which only the number of external supply connections can be configured by the number of distribution modules, and in which a supply module and a distribution modules form a module assembly;

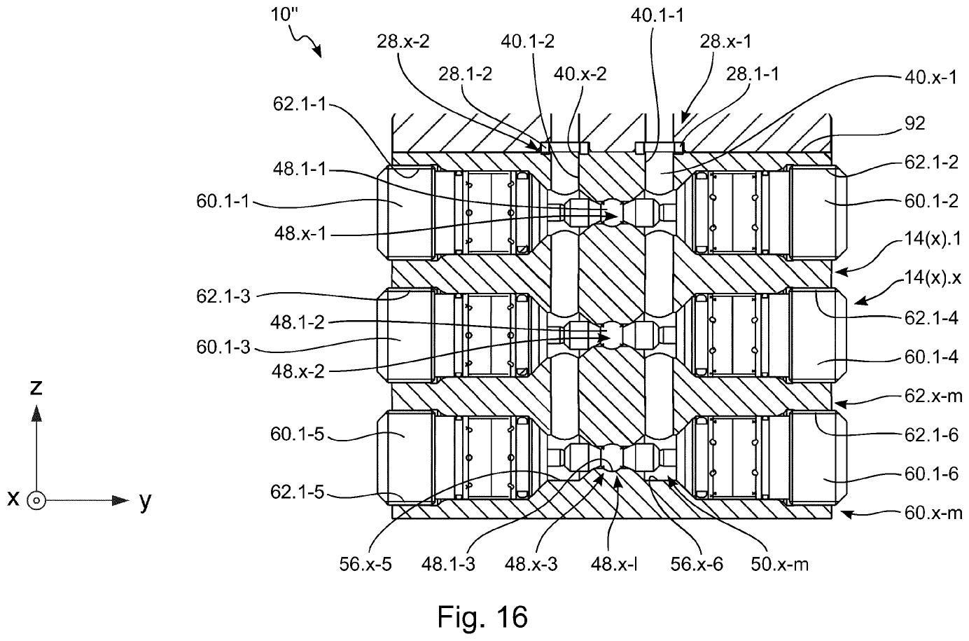

FIG. 16 a vertical section through a module assembly according to cut plane XVI in FIG. 15;

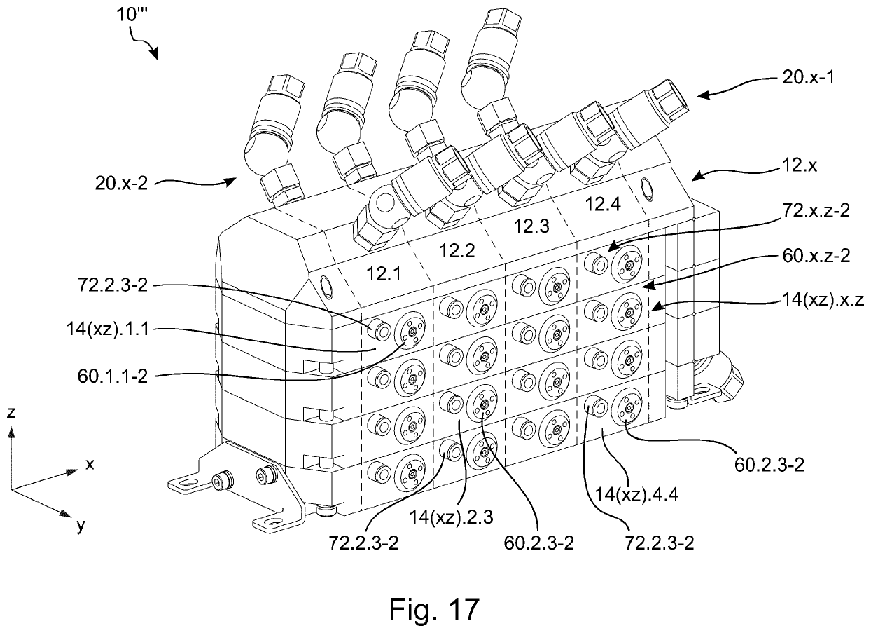

FIG. 17 a perspective view of a modular changing device according to a fourth embodiment, which comprises several connection modules, several distribution modules and a discharge connection module, and in which the number of supply connections and the number of discharge connections can be configured by the number of distribution modules.

Components and parts are assigned reference signs below which have a dot “.” followed by an index, for example 20.i or 28.i. Components and parts in which the index following the dot “.” has the same numerical value should be regarded as interacting components and parts, which in particular cooperate fluidically.

In addition, there are components and parts with reference signs which, after the index following the dot “.”, have a further index following a hyphen “-”. Indices after the hyphen “-” indicate that there are several components and parts which are linked correspondingly functionally to components for which the index following the dot “.” has the same numerical value as the index following the dot “.” of the component carrying the further index after the hyphen “-”. For example, components 64.3-1, 64.3-2 and 64.3-3 cooperate with components 66.3.

Following this system, reference signs are also attributed to components which are not explicitly evident in the figures, in order to clarify their interrelationship.

Firstly, reference is made to FIGS. 1 to 13 which show a modular changing device 10 for coating materials according to a first embodiment.

A reference coordinate system shown in the figures is fixedly anchored to the changing device 10 so that it moves spatially with the changing device 10.

The changing device 10 comprises a supply module 12, several distribution modules 14(z).z (with z=1 to Z), and a base module 16 which is arranged on the side of the distribution module 14(z).z lying remote from the supply module 12. In the embodiment shown, Z=2, and there are two distribution modules 14(z).1, 14(z).2. The designation 14(z) and the use of the index z illustrate that the distribution modules 14(z).z are designed such that they are or can be arranged successively in the Z direction.

The supply module 12 is now explained with reference to FIGS. 4 and 8 in which it only carries a single reference sign. The modules only carry their reference signs in the sectional view shown in FIG. 3.

The supply module 12 has, as a housing, a supply housing block 18 which provides external supply connections 20.i (with i=1 to L) for fluid materials, each of which may be connected to a fluid material reservoir (not shown here). The external supply connections 20.i are designed as hose receivers in the present embodiment.

The term “reservoir” in this case means any technical solution for supplying or receiving different fluids. These include for example ring line systems for fluids, as are known in themselves. The fluid materials may be coating materials, in particular paints, or cleaning fluids or gases, and in particular compressed air.

Via an external supply connection 20.i, a fluid material may be not only supplied to the changing device 10 but also discharged from the changing device 10.

In the present embodiment L=15, the total of 15 external supply points 20 comprise a compressed air connection 20.1 for compressed air from a compressed air reservoir, a solvent connection 20.2 for a solvent from a solvent reservoir, and 13 paint connections 20.3, 20.4, . . . 20.15 for different paints, each from an assigned paint reservoir, which do not all carry a reference sign. Conveying devices such as pumps, compressors and associated components for conveying individual fluid materials are not shown separately.

As shown in FIG. 4, the external supply connections 20.i are each connected via a supply channel 22.i (with i=1 to L) to respective coupling connections 24.i (with i=1 to L) on a coupling side 26 of the supply module 12. FIG. 4 shows this in the form of the supply channels 22.4 and 22.5 and the coupling connections 24.4 and 24.5 for the external supply connections 20.4 and 20.5. In the present embodiment, accordingly there are 15 such supply channels 22.1, 22.2, . . . , 22.15, and 15 coupling connections 24.1, 24.2, . . . , 24.15. The coupling side 26 in the present embodiment extends flat in the XY plane. The coupling connections 24.i are complementary in their arrangement and design to the arrangement and design of first connections 28.i (with i=1 to L) accessible from the outside, on a first connection side 30 of a housing 32 of a distribution module 14(z).z which also extends flat in the XY plane. The housing 32 is in practice formed as a housing block 36 from special steel so that small wall thicknesses are possible. Alternatively, plastics may be used.

In the present embodiment, the coupling connections 24.i of the supply module 12 are each formed as a connection recess 36, in which a sealing element in the form of an O-ring seal 37 may be placed such that it protrudes out of the connection recess 36, which is shown in FIG. 4 only for the coupling connection 24.5.

In the embodiments explained here and below, O-ring seals are always used as sealing elements. Alternatively, other known sealing elements could be used instead, such as for example Teflon rings or similar. Teflon rings are used in particular in fluid-conducting channels.

A distribution module 14(z).z is now explained with reference to the distribution module 14(z).1 in FIGS. 5 and 9, where again it only carries a single reference sign.

The first connections 28.i of the distribution module 14(z).z are configured as annular recesses 38 which are complementary to the O-ring seals 37 and in which the O-ring seals 37 can lie. If the above-mentioned Teflon rings are used as sealing elements, such complementary annular recesses 38 may be omitted so that the Teflon rings lie against the flat outer face of the distribution module 14(z).z. In this case, the complementarity indicates the cooperation of the connection recess 36 with the Teflon ring.

Each distribution module 14(z).z comprises several channels 40.i (with i=1 to L) which are configured as through-channels. Connections 28.i assigned to a through-channel 40.i in this case therefore form through-channel connections. The fluid channels 40.i each extend between an associated first connection 28.i on the first connection side 30 of the distribution module 14(z).z and an associated second connection 42.i (with i=1 to L) accessible from the outside on a second connection side 44. The number L of fluid channels 40.i corresponds to the number L of external supply connections 20.i.

In the present embodiment, the annular recess 38 of a first connection 28.i surrounds the opening of an associated fluid channel 40.i, each of which in the present embodiment runs in the Z direction.

The two connections 28.i and 42.i of each fluid channel 40.i are formed so as to be complementary to each other such that when two distribution modules 14(z).z are connected together, the second connections 42.i of the first module 14(z)—here the module 14(z).1—and the first connections 28.i of the second module 14(z)—here the module 14(z).2—are connected together fluid-tightly, as illustrated in FIG. 3 with no reference sign.

Accordingly, in the present embodiment, the second connections 42.i of the distribution module 14(z).z are configured as connection recesses 46, each for an O-ring seal 37, which is shown in FIG. 5 only for the second connection 42.5. The connection recesses 46 thus correspond to the connection recesses 36 of the supply module 12.

The distribution module 14(z).z also comprises a discharge channel 48 which can be connected to a consumer device and which is connected to the fluid channels 40.i via a respective flow path 50.i (with i=1 to L). A corresponding consumer device may for example be an application device for applying paint, but also a storage container or in some cases a further paint changer, or another device to which a fluid material is to be supplied via the changing device 10. The discharge channel 48 ends in a discharge connection 52, accessible from the outside, of the distribution module 14(z), via which fluid material can then be discharged from the distribution module 14(z).z.

The discharge connection 52 is shown only in FIGS. 1, 2 and 11. As evident there, the discharge connection 52 is connected as a separate component to the discharge channel 48. The discharge connection 52 may however also be an integral part of the discharge channel 48.

The discharge channel 48 extends perpendicularly to the fluid channels 40.i in the X direction. In FIGS. 3 and 5, it is evident that each flow path 50.i between a respective fluid channel 40.i and the discharge channel 48 is formed by a respective valve seat 54.i and a valve seat chamber 56.i for a sealing element 58.i of a valve 60.i actuated by compressed air, wherein in each case i=1 to L. In FIGS. 3 and 5, only one component in each case carries a reference sign. Accordingly, a valve 60.i is present for each fluid channel 40.i. Each valve 60.i is accommodated in a separate valve receiver 62.i (with i=1 to L) in the housing 32.

The valves 60.i form a closing device by means of which the flow path 50.i between the fluid channel 40.i and the discharge channel 48 can be selectively closed or opened.

In the present embodiment, the fluid channel 40.1, the first connection 28.1 of which is connected to the external supply connection 20.1, is arranged at the end of the discharge channel 48 remote from the discharge connection 52 and aligns with said channel, whereas the other fluid channels 40.2 to 40.15 are arranged in pairs on either side of the discharge channel 48; this is illustrated again in FIG. 11.

The distribution module 14(z).z comprises a plurality of compressed air input connections 64.i-j (with i=1 to L and j=1 to M) only shown in FIGS. 7 and 9, wherein a number M of compressed air input connections 64.i-j is assigned to each valve 60.i or each valve receiver 62.i. The compressed air input connections 64.i-j are accessible from the outside and arranged on the first connection side 30 of the distribution module 14(z).z. In the present embodiment M=3, i.e. for each valve 60.i or valve receiver 62.i, there is a first compressed air inlet connection 64.i-1, a second compressed air inlet connection 64.i-2 and a third compressed air inlet connection 64.i-3, giving a total of L×M or in the present case 15×3=45 compressed air inlet connections 64.i-j.

FIG. 9 accordingly shows the compressed air inlet connections 64.10-1, 64.10-2 and 64.10-3 which are assigned to the tenth valve 60.10 in the tenth valve receiver 62.10, and the compressed air inlet connections 64.11-j which are assigned to the eleventh valve 60.11 in the eleventh valve receiver 62.11.

A valve receiver 62.i is connected via a compressed air channel 66.i to the first compressed air inlet connection 64.i-1. The valve receiver 62.i, the compressed air channel 66.i opening therein and the valve 60.i are matched to each other such that the valve 60.i can be actuated by the compressed air present at the compressed air channel 64.i. In the present case, when loaded with compressed air, the valve 60.i opens the flow path 50.i between the fluid channel 40.i and the discharge channel 48.

In the embodiment shown, valves 60.i are used which have compressed air access openings 68.i (only shown in FIG. 6) in a ring groove 70.i on the outside of their valve housing (not designated separately). The valve receivers 62.i are formed so as to be complementary thereto, such that a gas-tight annular chamber 72.i is formed between the inner casing surface (not marked separately) of a valve receiver 62.i and the ring groove 70.i of the valve 60.i. If compressed air is applied to the first compressed air inlet connection 64.i-1 of the distribution module 14(z).z, this compressed air flows through the compressed air channel 66.i into the annular chamber 72.i and from there through the compressed air access openings 68.i of the valve 60.i, whereby the latter is actuated.

On the second connection side 44, the distribution module 14(z).z has a plurality of compressed air output connections 74.i-k (with i=1 to L and k=1 to N, wherein N=M−1), and a number N=M−1 of compressed air outlet connections 74.i-k is assigned to each valve 60.i or each valve receiver 62.i. The compressed air outlet connections 74.i-k are accessible from the outside.

In the present embodiment L=15, M=3 and hence N=2, i.e. for each valve 60.i or each valve receiver 62.i, there is a first compressed air outlet connection 74.i-1 and a second compressed air outlet connection 74.i-2, giving a total of L×N, in the present case 15×2=30 compressed air outlet connections 74.i-k.

In FIG. 9, accordingly, the compressed air outlet connections 74.10-1 and 74.10-2 are shown which are assigned to the tenth valve 60.10 in the tenth valve receiver 62.10, and the compressed air outlet connections 74.11-1 and 74.11-2 which are assigned to the eleventh valve 60.11 in the eleventh valve receiver 62.11.

A compressed air outlet connection 74.i-k is connected via a connecting channel 76.i-k to the compressed air inlet connection 64.i-j (with j=k+1). In the present case, this means for example that the first compressed air outlet connection 74.10-1 is connected via the first connecting channel 76.10-2 to the second compressed air inlet connection 64.10-2, or the second compressed air outlet connection 74.11-2 is connected via the second connecting channel 76.11-2 to the third compressed air inlet connection 64.11-3, as illustrated in FIG. 9.

The compressed air inlet connections 64.i-j and the compressed air outlet connections 74.i-k are now formed so as to be complementary to each other such that when two distribution modules 14(z).z are connected together, a respective compressed air outlet connection 74.i-k of the first module 14(z)—here module 14(z).1—and a respective compressed air inlet connection 64.i-j of the second module 14(z)—here module 14(z).2—are connected together fluid-tightly, wherein k=j. This is illustrated by FIG. 7, which shows that the compressed air inlet connection 64.10-1 of the second distribution module 14(z).2 is connected to the compressed air outlet connection 74.10-1 of the first distribution module 14(z).1, without separate reference signs being shown there.

For this complementarity, in the present embodiment the compressed air outlet connections 74.i-k on the second connection side 44 of the distribution module 14(z).z are formed as connection recesses 78, designated in FIG. 9 only for compressed air outlet connection 74.1-2. An O-ring seal 79 may be laid in the recess 78 so that it protrudes from the connection recess 78, as shown in FIG. 9 only for the compressed air outlet connection 74.10-1.

The compressed air inlet connections 64.i-j on the first connection side 30 of the distribution module 14(z).z are configured as annular recesses 80 complementary to the O-ring seals 79, and each surrounds an opening of the respective channel fed by the compressed air inlet connection 64.i-j, i.e. the compressed air channel 66.i or one of the connecting channels 76.i-k; an O-ring seal 79 can lie in each said recess. An annular recess 80 carries a reference sign in FIG. 9 only for the compressed air inlet connection 64.11-1.

In order for the distribution modules 14(z).z to be able to be supplied with compressed air, the supply module 12 on its coupling side 26 has a plurality of compressed air supply connections 82.i-j (with i=1 to L and j=1 to M) which are accessible from the outside, wherein for each valve 60.i or each valve receiver 62.1, there are a number M of compressed air supply connections 82.i-j which corresponds logically to the number of compressed air inlet connections 64.i j of the distribution module 14(z).z. In the present embodiment with M=3, for each valve 60.i or each valve receiver 62.i, there is therefore a first compressed air supply connection 82.i-1, a second compressed air supply connection 82.i-2 and a third compressed air supply connection 82.i-3, giving a total of L×M, i.e. in the present case 15×3=45 compressed air supply connections 82.i-j.

FIG. 8 accordingly shows compressed air supply connections 82.10-1, 82.10-2, 82.10-3 and 82.11-1, 82 11-2, 82-11.3.

The compressed air supply connections 82.i-j are formed so as to be complementary in their arrangement and design to the arrangement and design of the compressed air inlet connections 64.i-j of the distribution module 14(z).z. In the present embodiment, compressed air supply connections 82.i-j of the supply module 12 are again configured as connection recesses 84, in each of which an O-ring seal 85 may be placed such that it protrudes from the connection recess 84, so that it can lie in the corresponding annular recess 80 of the associated compressed air inlet connection 64.i-j when the supply module 12 is connected to the distribution module 14(z).1. This is indicated in FIG. 8 only for the compressed air supply connection 82.10-1.

The supply module 12 has a plurality of external compressed air connections 86.i-j (with i=1 to L and j=1 to M), each of which is connected via a compressed air line 88.i-j to a respective compressed air supply connection 82.i-j of the supply module 12. The external compressed air connections 86.i-j may each be loaded separately with compressed air under valve control from a compressed air source (not shown separately). In FIG. 8, external compressed air connections 86.10-1 and 86.10-2, and 86.11-1 and 86.11 2 can be seen accordingly. The external compressed air connections 86.10-3 and 86.11-3 lie in front of the section plane.

The base module 16 is now explained with reference to FIGS. 6 and 10, where it only carries single reference signs. The base module 16 is in principle designed like the distribution module 14(z).z, so functionally corresponding parts and components carry the same reference signs.

Instead of a second connection side 44, the base module 16 has a closed support side 90 and an opposite connection side 92 which corresponds to the first connection side 30 of the distribution module 14(z).z. Accordingly, first connections 28.i are present on this connection side 92 of the base module 16 which are complementary to the second connections 42.i of the distribution module 14(z).z.

Instead of the fluid through-channels 40.i, in the base module 16 discontinuous fluid channels 94.i are present which are formed as blind channels and terminate the fluid channels 40.i formed as through-channels in the adjacent distribution module. The fluid channels 94.i each extend from an associated connection 28.i to the associated valve seat chamber 56.i of the base module 16.

In the base module 16, only a single compressed air inlet connection 64.i-j (with i=1 to L and j=1) is assigned to each valve 60.i or each valve receiver 62.i, and consequently carries reference sign 64.i-1. FIG. 10 accordingly shows the compressed air inlet connections 64.10-1 and 64.11-1. The compressed air inlet connections 64.i-1 of the base module 16 are complementary in arrangement and design to the respective first compressed air outlet connections 74.i-1 of the distribution module 14(z).z.

The discharge channel 48 of the base module 16 opens into an external dump connection 96 which can be connected to a discharge line and is shown in FIGS. 1 and 2.

So that the supply module 12, the distribution modules 14(z).z and the base module 16 can be joined together securely and with correct fit of the connections to be joined, and can thus be connected together, modules 16, 14(z).z and 16 have several centering channels 98 in which centering pins 100 may be inserted, so that the modules 12, 14(z).z and 16 can be guided onto each other. The centering channels 98 are shown in FIGS. 11, 12 and 13. The centering pins 100 are shown only on FIG. 13. For the distribution modules 14(z).z, the centering channels 98 are configured as through-channels from the first connection side 30 to the second connection side 44. In the supply module 12 and in the base module 16 however, the centering channels 98 are blind holes. The centering channels 98 are provided at the outer left corners of modules 12, 14(z).z and 16 in FIGS. 11 and 12.

In order for modules 12, 14(z).z and 16 to be able to be connected fixedly together, modules 12, 14(z).z and 16 also have screw channels 102, through which screws 104 can be guided. Screw channels 102 are shown in FIGS. 7 to 13, wherein in FIGS. 11 and 12 these are shown as a double circle; not all screw channels 102 carry a reference sign. Screws 104 are shown only in FIGS. 7 and 13. In the present embodiment, the screws 104 are introduced from the base module 16. On the end facing the supply module 12, the screws 184 have a thread which engages in a corresponding counter thread in the associated screw channel 102 in the supply module 12.

In the above-mentioned embodiment, the maximum number Z of distribution modules 14(z).z which can be arranged between the supply module 12 and the base module 16 depends on the number M of compressed air inlet connections 64.i-j per valve 60.i and per valve receiver 62.i, and Z=M−1.

If the changing device 10 is assembled from two distribution modules 14(z).1 and 14(z).2, each first compressed air supply connection 82.i-1 of the supply module 12 now leads via the associated first compressed air inlet connection 64.i-1 of the first distribution module 14(z).1 and on via its channel 66.i to the corresponding valve 60.i in the first distribution module 14(z).1.

Each second compressed air supply connection 82.i-2 of the supply module 12 leads via the associated second compressed air inlet connection 64.i-2 of the first distribution module 14(z).1 and its first connecting channel 76.i-1 to the first compressed air outlet connection 74.i-1, which is coupled to the first compressed air inlet connection 64.i-1 of the second distribution module 14(z).2, whereby accordingly the valve 60.i of the second distribution module 14(z).2 can be loaded via its channel 66.1.

Each third compressed air supply connection 82.i-3 of the supply module 12 leads via the associated third compressed air inlet connection 64.i-3 of the first distribution module 14(z).1 and its second connecting channel 76.i-2 to the second compressed air outlet connection 74.i-2, which is coupled to the second compressed air inlet connection 64.i-2 of the second distribution module 14(z).2. The first connecting channel 76.i-1 of the second distribution module 14(z).2 then leads on to the first compressed air outlet connection 74.i-2 of the second distribution module 14(z).2, which in turn is connected to the compressed air inlet connection 64.i-1 of the base module 16. The valve 60.i of the base module 16 can thus be loaded with compressed air via its channel 66.1 accordingly.

As clearly evident in FIG. 7 from the second distribution channels 76.10-2 and 76.11-2 of the second distribution module 14(z).2, its second connecting channels 76.i-2 have no function here since they extend between closed faces of the second connection side 44 of the first distribution module 14(z).1 and the connection side 90 of the base module 16.

If more compressed air inlet connections 64.i-j for each valve 60.i or each valve receiver 62.i were provided, with for example M=4 or M=5, wherein accordingly N=3 or N=4 compressed air outlet connections 74.i-k would also be present, a third or even a fourth distribution module 14(z).3 or 14(z).4 could be integrated in the changing device 10.

The changing device 10 may but need not comprise the maximum possible number Z of distribution modules 14(z).z. Thus the changing device 10 with the distribution modules 14(z).z explained here may also comprise only a single such distribution module 14(z).1. In this case, the second connecting channels 76.i-2, which are each connected to an external compressed air connection 82.i-3 of the supply module 12, would lead to the closed face of the connection side 92 of the base module 16. Its compressed air inlet connections 64.i-1 are connected to the first connecting channels 76.i-1 of the distribution module 14(z).1 and may thus be loaded with compressed air via the second external compressed air connections 82.i-2 of the supply module 12 in order to actuate the valves 60.i in the base module 16.

In principle, the changing device described above is structured such that only the number of discharge connections can be configured by the number of distribution modules; it is not possible simply to change the number of external supply connections 20.i and hence change the number of selectable paints.

In a derivative (not shown separately), a third distribution module 14(z).z may also serve as a base module. If the changing device 10 is to be established in a ring line system, a further supply module 12 with corresponding external supply connections 20.i may be attached at the second connection side 14, so that the changing device 10 with two external supply connections 20.i may be installed in a corresponding ring line.

If, instead, a type of base module is to be formed, the second connections 42.i of the second connection side 44 of the third distribution module may be closed. For example, blind plugs may be provided for this, or a terminating plate with corresponding plugs may be applied.

In the changing device 10 presented above, the discharge channels 48 of the distribution modules 14(z).z are now each connected to a consumer device, for example a high-rotation atomizer, and the discharge channel 48 of the base module 16 is connected to the above-mentioned discharge line via the external dump connection 96. In some cases however, the discharge line 48 of the base module 16 may also be connected to a consumer device, so then also the discharge line 48 of the base module 16 opens into a corresponding discharge connection 52. In this case, one of the external supply connections 20.i on the supply module 12 serves as an external dump connection. If this is for example the external supply connection 20.1, the associated fluid channels 40.1 in the distribution modules 14(z).z, and the fluid channel 94.1 in the base module 16 are not used like the other fluid channels 40.2 to 40.15 and 94.2 to 94.15 for supplying fluid material to the discharge channels 48, but serve to discharge fluid material from the discharge channels 48 of the distribution modules 14(z).z and the base module 16.

In a further derivative, both the discharge line 48 of the base module 16 and the fluid channels 94.1 of the base module 16 and 40.1 of the distribution modules 14(z).z with the associated external supply connection 20.1 are used as dump lines. In particular, the system can be efficiently purged via the latter when required.

During operation of the changing device 10 explained above, the different paints are now pressed via the external supply connections 20.4 to 20.15 into the individual fluid channels 40.i and 94.i connected therewith, as far as the valve seat chambers 56.i in the base module 16.

If a paint present in one of the fluid channels 40.i is not used for a lengthy period, the associated valve 60.i in the base module 16 may open the flow path 50.i there and discharge the desired quantity of stored paint via the discharge line 48 and dump connection 20.16 for disposal.

Otherwise, the changing device 10 is operated as usual for other known commercial changing devices.

FIG. 14 shows a changing device 10′ according to a second embodiment, which is formed from two derived changing devices 10 according to FIGS. 1 to 7, and in which instead of the base module 16, a respective third distribution module 14(z).3 is used. These form partial changing devices of the changing device 10′ and are designated 10A and 1013 in FIG. 11.

The two partial changing devices 10A and 10B are placed against each other and connected together such that the two second connection sides 44 of the respective third distribution modules 14(z).3 lie against each other. In this case, the respective connection recesses 46 (not shown in FIG. 14) of the second connections 42.i of both the first partial change device 10A and of the second partial change device 10B lie opposite each other. In order to achieve a fluid-tight connection, O-ring seals of larger axial extent than the O-ring seals 37 are used.

The external supply connections 20.i of the supply modules 12 of the partial changing devices 10A and 1013 are each connected to a ring line so that the changing device 10′, for each of the 13 possible paints, provides a total of six discharge lines 48 with discharge connections 52, of which only one carries a reference sign in FIG. 14.

As evident in FIG. 14 from the first and second connecting channels 76.10-1, 76.10-2 and 76.11-1, 76-11.2 of the third distribution module 14(z).3, and the connecting channels 76.10-1 and 76.11-1 of the second distribution module 14(z).2, the first and second connecting channels 76.i-1 and 76.i-2 of the third distribution modules 14(z).3 and the second connecting channels 76.i-2 of the second distribution modules 14(z).2 of the partial changing devices 10A and 1013 have no function since no compressed air can be supplied thereto.

FIG. 15 shows a modular changing device 10″ according to a third embodiment in which only the number of supply connections can be configured by the number of distribution modules.

In the changing device 10″, derived supply modules 12.x and derived distribution modules 14(x).x are present, with x=1 to X, wherein in the embodiment shown here X=4. Each supply module 12.x carries two external supply connections 20.x-1 and 20.x-2, and accordingly on its coupling side 26 has two coupling connections 24.x-1 and 24.x-2.

In each case, a supply module 12.x and a distribution module 14(x).x, in which the indices x have the same numerical value, form a module assembly 106(x).x.

The designations 14(x) and 106(x), and the use of the respective index x, illustrate that the distribution modules 14(x).x or module assemblies 106(x).x are designed such that they are or can be arranged successively in the X direction.

As FIG. 16 shows, the vertical section of the distribution modules 14(x).x corresponds to the vertical section of the changing device 10 in FIG. 7. The distribution module 14(x).x, like the base module 16, only has one connection side 92 on which only two connections are present; these are designated 28.x-1 and 28.x-2 and are complementary to the coupling connections 24.i of the distribution modules 14(z).z.

The designation of the parts and components identified in FIG. 16 means that the respective index x can be replaced by the figure which is also assigned to the distribution module 14(x).x concerned.

Since therefore the first distribution module 14(x).1 is shown, in FIG. 16 for example the connections marked 28.x-1 and 28.x-2 correspond to connections 28.1-1 and 28.1-2 of the first distribution module 14(x).1. The third distribution module 14(x).3 accordingly has connections 28.3-1 and 28.3-2.

In contrast to the base module 16, a distribution module 14(x).x has in the Z direction discharge channels 48.x-I, with I=1 to 0, wherein in the present embodiment O=3, and accordingly three discharge channels 48.x-1, 48.x-2 and 48.x-3 are present which are connected via corresponding flow paths 50.x-m to two fluid channels 40.x-1 and 40.x-2. The flow paths 50 are not designated separately in FIG. 16.

Here m=O×2, i.e. in the present embodiment, six flow paths 50.x-1 to 50.x-6 are present. Accordingly, the distribution module 14(x).x also comprises valves 60.x-m, i.e. here six valves 60.x-1 to 60.x-2, which are received in corresponding valve receivers 62.x-m, i.e. here six valve receivers 62.x-1 to 62.x-6.

The fluid channels 40.x-1 and 40.x-2 are not continuous and each runs from an associated connection 28.x-1 or 28.x-2 up to the associated lowest valve seat chamber 56.x-5 or 56.x-6.

In a further derivative of the distribution modules 14(z).z, the distribution modules 14(x).x carry, for each valve 60.x-1 to 60.x-6, separate external compressed air connections 86.x-m which are connected to the respective annular chambers designated 72.x-m; this is shown in FIG. 15.

Accordingly, there are no external compressed air connections on the supply modules 12.x, and also there are no connecting channels for compressed air like the connecting channels 76.i-k in the distribution modules 14(z).z.

Alternatively, the distribution modules 14(x).x may be configured correspondingly to the distribution modules 14(z).z, and compressed air may be supplied via the respective supply module 12.x.

The discharge channels 48.x-I are configured as through-channels and each extend between a first connection accessible from the outside, on a first discharge side of the housing 32, and a second connection accessible from the outside, on a second discharge side of the housing 32. However, this corresponds to the principle in the fluid channels 40.i of the distribution modules 40.i, wherein the connections of the discharge channels 40.x-I and the discharge sides of the housing 32 of the distribution modules 14(x).x are not shown individually in FIGS. 12 and 13.

The two connections of the discharge channel 48.x-I are however formed so as to be complementary to each other such that when two distribution modules 14(x).x1 and 14(x).x2 (with x2=x1+1) are connected together, the second connections of the first distribution module 14(x).x1 and the first connections of the second distribution module 14(x).x2 are connected together fluid-tightly.

In this way, the changing device 10″ may be extended in the X direction, wherein each module unit 106(x).x is composed of a supply module 12.x and a distribution module 14(x).x placed against each other. The discharge channels 48.x-1, 48.x-2 of the distribution module 14(x).x which is the last in the X direction (in the present case distribution module 14(x).4) are connected to a respective discharge connection 52 of discharge connection unit 108 which is attached to this last distribution module 14(x).x, whereas the third discharge channel 48.x-3 (i.e. in this case the discharge channel 48.4-3) is connected to the external dump connection 96.

On the side remote from the discharge connections 52 and external dump connection 96, the first distribution module 14(x).1 is closed by a closure plate 110 which seals the discharge channels 48.1-1, 48.1-2 and 48.1-3.

FIG. 17 shows as a fourth embodiment a changing device 10′″, in which the number of supply connections and the number of discharge connections may be configured by the number of distribution modules.

There, the supply modules 12.x according to FIGS. 12 and 13 cooperate again with modified distribution modules 14(xz).x.z and base modules 16(xz).x.z. The reference sign 14(xz) and the use of the indices .x and .z indicate that the distribution modules 14(xz).x.z are designed such that they are or can be arranged in the XZ plane in a matrix in the X direction and in the Z direction. The indices .x show the position of the distribution modules 14(xz).x.z in the X direction, and indices .z show the position of the distribution modules 14(xz).x.z in the Z direction, starting from the distribution module 14(xz).1.1 at the top left in FIG. 17, in which as an example the distribution modules 14(xz).2.3 and 14(xz)4.4 also carry separate reference signs.

The distribution modules 14(xz).x.z are configured as a type of module bar which has an discharge channel 48.x.z and two fluid through-channels 40.x.z-1 and 40.x.z-1, each with a first connection 28.x.z-1 and 28.x.z-2, and each with a second connection 42.x.z-1 and 42.x.z-2, wherein these components are not shown separately. Two valves 60.x.z-1 and 60.x.z-2 are provided which are received in valve receivers 62.x.z-1 and 62.x.z-2 and can open or close two flow paths 50.x.z-1 and 50.x.z-2. In FIG. 17, only valves 60.x.z-2 can be seen.

For each valve 60.x.z-1 and 60.x.z-2, the distribution modules 14(xz).x.z carry separate external compressed air connections 86.x.z-1 or 86.x.z-2 which are connected to the respective annular chambers designated 72.x.z-1 or 72.x.z-2.

Distribution modules 14.1.1, 14.1.3 and 14.1.4 for example cooperate with the supply module 12.1; the distribution module 14.3.3 is fed for example by supply module 12.3.

The distribution modules 14.x.z may be connected together in the X direction as explained in relation to the changing device 10″ in FIGS. 15 and 16. Also, the distribution modules 14.x.z can be connected together in the Z direction, as explained above in relation to the changing device 10 according to FIGS. 1 to 7, or the changing device 10′ according to FIG. 11.

The changing device 10”” can thus be extended in the X direction and in the Z direction so that both the number of the external supply connections 20.x-1 and 20.x-2, and also the number of discharge channels 48.x.z, can be varied.

What is claimed is:

1. A module for a modular changing device for coating materials, comprising:
a) a housing;
b) a fluid channel to which a fluid material can be supplied from the outside;
c) a discharge channel which can be connected to a consumer device and is connected to the fluid channel by means of a flow path;
wherein
d) the flow path between the fluid channel and the discharge channel can be selectively closed or opened by means of a closing device,
further wherein
e) the fluid channel is formed as a through-channel and extends between a first connection accessible from the outside, on a first connection side of the housing, and a second connection, accessible from the outside, on a second connection side of the housing,
wherein
the first connection and the second connection of the fluid channel are formed so as to be complementary to each other such when two modules are connected together, the second connection of the first module and the first connection of the second module are connected together fluid-tightly;
and/or
f) the discharge channel is a first discharge channel and the module comprises a second discharge channel or several further discharge channels, which are each connected to the fluid channel by means of a flow path.

2. The module as claimed in claim 1, wherein
a) the discharge channel is formed as a through-channel and extends between a first connection accessible from the outside, on a first discharge side of the housing, and a second connection accessible from the outside, on a second discharge side of the housing;
b) the two connections of the discharge channel are formed so as to be complementary to each other such that when two modules are connected together, the second connection of the first module and the first connection of the second module are connected together fluid-tightly.

3. The module as claimed in claim 1, wherein the first connection of the fluid channel and/or the discharge channel, and/or the second connection of the fluid channel and/or the discharge channel are formed as complementary openings which cooperate with a sealing element.

4. The module as claimed in claim 1, wherein the fluid channel is a first fluid channel and the module comprises a second fluid channel or several further fluid channels, each of which can be supplied with fluid material from the outside.

5. The module as claimed in claim 1, wherein the closing device comprises a valve which is actuated by compressed air and can be loaded with compressed air via a compressed air input connection.

6. The module as claimed in claim 5, wherein
a) the compressed air input connection is a first compressed air input connection on the first connection side of the module, and the module comprises at least one second compressed air input connection on the first connection side, which is connected via a connecting channel to a compressed air output connection on the second connection side,
wherein
b) the first compressed air input connection and the compressed air output connection are formed so as to be complementary to each other such that when two modules are connected together, the compressed air output connection of the first module and the first compressed air input connection of the second module are connected together fluid-tightly.

7. The module as claimed in claim 6, wherein the module has a number M≥3 of compressed air input connections and a number N=M−1 of compressed air output connections, wherein every further compressed air input connection after the third is connected via a connecting channel to a respective one of the further compressed air output connections after the second, and every compressed air input connection after the second and every compressed air output connection after the second are formed so as to be complementary to each other such that when two modules are connected together, every compressed air input connection after the second said connection of the first module is connected to a respective compressed air output connection after the second said connection of the second module.

8. A changing device for coating material which is constructed from several modules, wherein at least one module comprises
a) a housing;
b) a fluid channel to which a fluid material can be supplied from the outside;
c) a discharge channel which can be connected to a consumer device and is connected to the fluid channel by means of a flow path;
wherein
d) the flow path between the fluid channel and the discharge channel can be selectively closed or opened by means of a closing device,
further wherein
e) the fluid channel is formed as a through-channel and extends between a first connection accessible from the outside, on a first connection side of the housing, and a second connection, accessible from the outside, on a second connection side of the housing,
wherein
the first connection and the second connection of the fluid channel are formed so as to be complementary to each other such when two modules are connected together, the second connection of the first module and the first connection of the second module are connected together fluid-tightly;
and/or
f) the discharge channel is a first discharge channel and the module comprises a second discharge channel or several further discharge channels, which are each connected to the fluid channel by means of a flow path.

9. The changing device as claimed in claim 8, wherein a supply module is provided which can be connected to the at least one module and provides one or more external supply connections for fluid materials, wherein an existing external supply connection can be connected to a first connection of an existing fluid channel.

10. The changing device as claimed in claim 9, wherein the supply module has a coupling connection for each existing first connection of a fluid channel of the at least one module wherein said coupling connection is connected to an external supply connection and is complementary to the first connection of the fluid channel.

11. The changing device as claimed in claim 9 wherein the supply module comprises one or more external compressed air connections which are connected to compressed air supply connections which in turn are complementary to existing compressed air input connections of a module having a compressed air input connection having a first compressed air input connection on the first connection side of the module, and the module comprises at least one second compressed air input connection on the first connection side, which is connected via a connecting channel to a compressed air output connection on the second connection side, wherein the first compressed air input connection and the compressed air output connection are formed so as to be complementary to each other such that when two modules are connected together, the compressed air output connection of the first module and the first compressed air input connection of the second module are connected together fluid-tightly.

12. The changing device as claimed in claim 8, wherein on the side, remote from the supply module (12), of the at least one module, a base module is arranged which comprises one or more discontinuous fluid channels formed as blind channels, each of which terminates a fluid channel formed as a through-channel of the adjacent module as claimed in claim 1.
